(19) United States
(12) Patent Application Publication
(10) Pub. No.: US 2024/0129169 A1
(43) Pub. Date: Apr. 18, 2024

(54) TRAINING METHOD, ARITHMETIC PROCESSING DEVICE, AND COMPUTER-READABLE RECORDING MEDIUM STORING TRAINING PROGRAM

(71) Applicant: Fujitsu Limited, Kawasaki-shi (JP)

(72) Inventor: Yasumasa OTA, Yokohama (JP)

(73) Assignee: Fujitsu Limited, Kawasaki-shi (JP)

(21) Appl. No.: 18/351,271

(22) Filed: Jul. 12, 2023

(30) Foreign Application Priority Data
Oct. 13, 2022 (JP) 2022-164788

(51) Int. Cl. H04L 25/03

(52) U.S. Cl. CPC H04L 25/03267; H04L 25/03821

(57) ABSTRACT

A training method for causing a computer to execute process, the process includes measuring an inter-symbol interference value generated in a transmission path of double data rate (DDR) transmission that uses a decision feedback equalizer (DFE) circuit, based on a control result of a training pattern, a voltage reference value of a dynamic random access memory (DRAM), and a tap value of the DFE circuit, and obtaining a set tap value to be set in the DFE circuit, based on the measured inter-symbol interference value.

### CROSS-REFERENCE TO RELATED APPLICATION

This application is based upon and claims the benefit of priority of the prior Japanese Patent Application No. 2022-164788, filed on Oct. 13, 2022, the entire contents of which are incorporated herein by reference.

### FIELD

The embodiment discussed herein is related to a training method, an arithmetic processing device, and a training program.

### BACKGROUND

In double data rate (DDR) transmission, a decision feedback equalizer (DFE) circuit is sometimes mounted in a receiver circuit with improvement of transmission speed. A DFE circuit is a circuit for canceling inter-symbol interference (ISI) of a transmission path to increase a transmission margin, and it is necessary to appropriately set a DFE TAP value in order to appropriately move the DFE. As a method of determining the DFE TAP value, for example, an optimum DFE TAP value is obtained by causing a test pattern to flow and measuring an eye margin while sweeping the DFE TAP value.

Japanese Laid-open Patent Publication No. 2021-119551 and Japanese Laid-open Patent Publication No. 2017-060106 are disclosed as related art.

### SUMMARY

According to an aspect of the embodiments, a training method for causing a computer to execute process, the process includes measuring an inter-symbol interference value generated in a transmission path of double data rate (DDR) transmission that uses a decision feedback equalizer (DFE) circuit, based on a control result of a training pattern, a voltage reference value of a dynamic random access memory (DRAM), and a tap value of the DFE circuit, and obtaining a set tap value to be set in the DFE circuit, based on the measured inter-symbol interference value.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a block diagram schematically illustrating a hardware configuration example of an arithmetic processing device according to an embodiment;

FIG. 2 is a table illustrating training patterns according to the embodiment;

FIG. 3 is a flowchart for describing training processing of a DFE TAP value according to the embodiment;

FIG. 4 is a flowchart for describing details of TAP determination processing illustrated in FIG. 3;

FIG. 5 is a graph illustrating waveforms at a dynamic random access memory (DRAM) input terminal during training according to the embodiment;

FIG. 6 is a table illustrating training patterns according to a modification;

FIG. 7 is a table illustrating correspondence between a training TAP and a use pattern according to a modification;

FIG. 8 is a flowchart for describing details of TAP determination processing illustrated in FIG. 3 according to a modification;

FIG. 9 is a graph illustrating waveforms at a DRAM input terminal during training according to a modification;

FIG. 10 is a flowchart for describing training processing of a DFE TAP value according to a modification;

FIG. 11 is a flowchart for describing details of TAP1 determination processing illustrated in FIG. 10;

FIG. 12 is a flowchart for describing details of the TAP1 determination processing illustrated in FIG. 10;

FIG. 13 is a flowchart for describing details of TAP2 increase processing illustrated in FIG. 12;

FIG. 14 is a flowchart for describing details of TAP2 determination processing illustrated in FIG. 10;

FIG. 15 is a flowchart for describing details of the TAP2 determination processing illustrated in FIG. 10; and

FIG. 16 is a flowchart for describing details of TAP1 increase processing illustrated in FIG. 15.

### DESCRIPTION OF EMBODIMENTS

In the case of the above-described method in which an optimum DFE TAP value is obtained by causing a test pattern to flow and measuring an eye margin while sweeping the DFE TAP value, since it is necessary to cause a long data pattern to flow every time the DFE TAP value is swept, it may take a very long time to obtain the optimum DFE TAP value.

### [A] Embodiment

Hereinafter, an embodiment of techniques capable to accurately set a tap value of a DFE circuit in a short time will be described with reference to the drawings. Note that the embodiment to be described below is merely an example, and there is no intention to exclude application of various modifications and techniques not explicitly described in the embodiment. For example, the present embodiment may be variously modified and performed in a range without departing from the spirit thereof. Furthermore, each drawing is not intended to include only components illustrated in the drawing, and may include another function and the like. Hereinafter, the same reference numerals in the respective drawings have similar functions, and thus description thereof may be omitted.

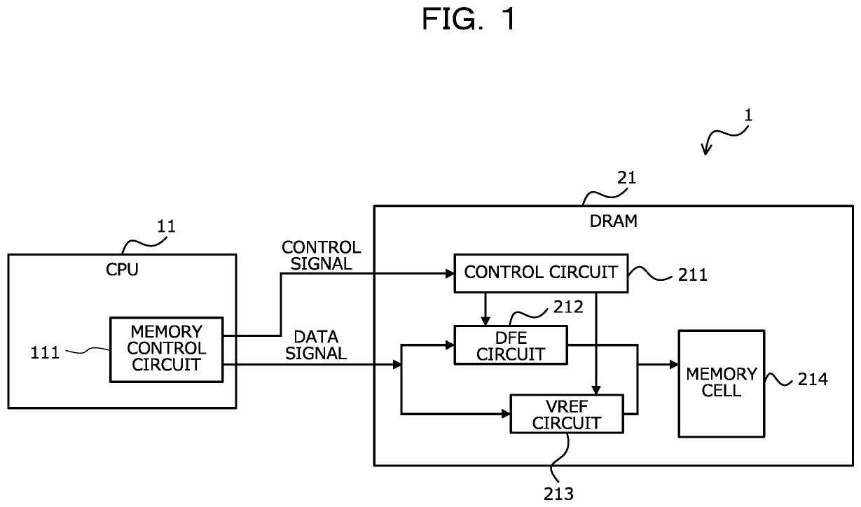

FIG. 1 is a block diagram schematically illustrating a hardware configuration example of an arithmetic processing device 1 according to the embodiment.

The arithmetic processing device 1 includes a central processing unit (CPU) 11 and a DRAM 21.

The CPU 11 is illustratively a processing device that performs various controls and calculations, and implements various functions by executing an operating system (OS) and a program stored in the DRAM 21.

Note that the program that implements various functions may be provided in a form recorded in a computer-readable recording medium such as a flexible disk, a compact disc (CD) (CD read-only memory (CD-ROM), CD-recordable (CD-R), CD-rewritable (CD-RW), etc.), a digital versatile disc (DVD) (DVD-ROM, DVD random access memory (DVD-RAM), DVD-R, DVD+R, DVD-RW, DVD+RW, high definition (HD) DVD, etc.), a Blu-ray disc, a magnetic disc, an optical disc, a magneto-optical disc, or the like. Then, a computer (the CPU 11 in the present embodiment) may read the program from the above-described recording medium via a reading device (not illustrated), transfer and store the read program to an internal recording device or an external recording device, and use the program. Furthermore, the program may also be recorded in a storage device (recording medium), for example, a magnetic disc, an optical disc, a magneto-optical disc, or the like, and may also be provided to the computer from the storage device via a communication path.

When functions are implemented in the CPU 11, the program stored in the internal storage device (the DRAM 21 in the present embodiment) may be executed by the computer (the CPU 11 in the present embodiment). Furthermore, the computer may also read and execute the program recorded in the recording medium.

The CPU 11 illustratively controls an operation of the entire arithmetic processing device 1. The device for controlling the operation of the entire arithmetic processing device 1 is not limited to the CPU 11 and may be, for example, any one of an MPU, a DSP, an ASIC, a PLD, or an FPGA. Furthermore, the device for controlling the operation of the entire arithmetic processing device 1 may be a combination of two or more types of the CPU, MPU, DSP, ASIC, PLD, or FPGA. Note that the MPU is an abbreviation for a micro processing unit, the DSP is an abbreviation for a digital signal processor, and the ASIC is an abbreviation for an application specific integrated circuit. Furthermore, the PLD is an abbreviation for a programmable logic device, and the FPGA is an abbreviation for a field programmable gate array.

As illustrated in FIG. 1, the arithmetic processing device 1 may function as a memory control circuit 111. The memory control circuit 111 controls the DRAM 21 by inputting a control signal and a data signal to the DRAM 21.

The DRAM 21 is used as a primary recording memory or a working memory, and may have functions as a control circuit 211, a DFE circuit 212, a voltage reference (VREF) circuit 213, and a memory cell 214.

The control circuit 211 controls the DFE circuit 212 and the VREF circuit 213 based on the control signal from the memory control circuit 111 of the CPU 11.

The DFE circuit 212 is a circuit for canceling an ISI of a transmission path to increase a transmission margin, and controls the memory cell 214 based on the data signal from the memory control circuit 111 of the CPU 11 and the signal from the control circuit 211.

The VREF circuit 213 supplies a constant voltage to the memory cell 214 based on the data signal from the memory control circuit 111 of the CPU 11 and the signal from the control circuit 211.

The memory cell 214 has a circuit configuration as a minimum unit for storing and reading information in the DRAM 21.

In DDR transmission using the DFE circuit 212, the arithmetic processing device 1 in the embodiment sets an appropriate DFE value using only functions defined in a DRAM standard. The arithmetic processing device 1 appropriately controls a training data pattern, a VREF value (for example, a voltage reference value) of the DRAM 21, and a DFE TAP value (for example, a tap value of the DFE circuit 212) of the DRAM 21. Thereby, it becomes possible to directly measure the ISI generated in the transmission path and to obtain an appropriate DFE TAP value with high accuracy in a short time.

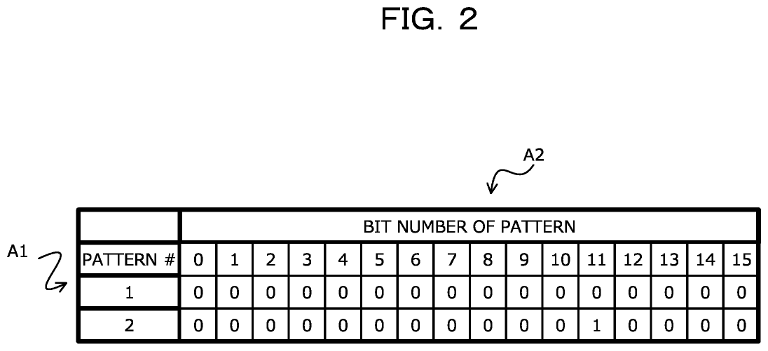

FIG. 2 is a table illustrating training patterns according to the embodiment.

In the embodiment, training processing of the DFE TAP value may be executed using the training patterns illustrated in FIG. 2.

In the training patterns, each of bit numbers 0 to 15 indicated by reference numeral A2 is associated with patterns #1 and #2 indicated by reference numeral A1.

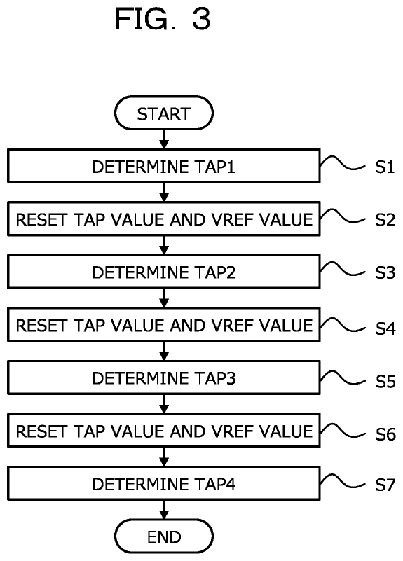

The training processing of the DFE TAP value in the embodiment will be described according to the flowchart (operations S1 to S7) illustrated in FIG. 3.

The memory control circuit 111 illustrated in FIG. 1 determines TAP1 (operation S1).

The memory control circuit 111 resets the TAP value and the VREF value (operation S2).

The memory control circuit 111 determines TAP2 (operation S3).

The memory control circuit 111 resets the TAP value and the VREF value (operation S4).

The memory control circuit 111 determines TAP3 (operation S5).

The memory control circuit 111 resets the TAP value and the VREF value (operation S6).

The memory control circuit 111 determines TAP4 (operation S7). Then, the training processing of the DFE TAP value in the embodiment ends.

Next, details of the TAP determination processing illustrated in FIG. 2 will be described with reference to the flowchart (operations S11 to S13) illustrated in FIG. 3.

In TAP1 determination, the memory control circuit 111 searches for the VREF value (VREF1) at which a determination value of bit12 is switched from 1 to 0 by adjusting (sweeping) the VREF circuit 213 while causing the pattern #1 (for example, the first training pattern) illustrated in FIG. 2 to flow (operation S11).

The memory control circuit 111 searches for the TAP value (ISI1; for example, an inter-symbol interference value) at which the determination value of bit12 is switched from 0 to 1 or from 1 to 0 by adjusting (sweeping) TAP1 while causing the pattern #2 (for example, the second training pattern) illustrated in FIG. 2 to flow (operation S12).

The memory control circuit 111 calculates the TAP value to be set to TAP1 by halving the searched ISI1 (operation S13). Then, the TAP determination processing ends.

Note that the processing in operations S11 to S13 is executed with the determination bit set to bit13 when TAP2 is determined, the processing in operations S11 to S13 is executed with the determination bit set to bit14 when TAP3 is determined, and the processing in operations S11 to S13 is executed with the determination bit set to bit15 when TAP4 is determined.

Note that the bit pattern illustrated in FIG. 2 may be obtained by inverting 0 and 1. For example, a pattern (for example, a third training pattern) obtained by inverting the pattern #1 (for example, the first training pattern) and a pattern (for example, a fourth training pattern) obtained by inverting the pattern #2 (for example, the second training pattern) may be used. In this case, the search is performed such that the switching of the determination value in each bit is reversed.

Furthermore, an average value of the TAP value obtained with the bit pattern illustrated in FIG. 2 and the TAP value obtained with the inverted bit pattern may be set as the TAP value to be set. Thereby, it is possible to select the DFE TAP value equally appropriate for both of rising and falling waveforms of transmission data waveform in a case where the waveforms are different.

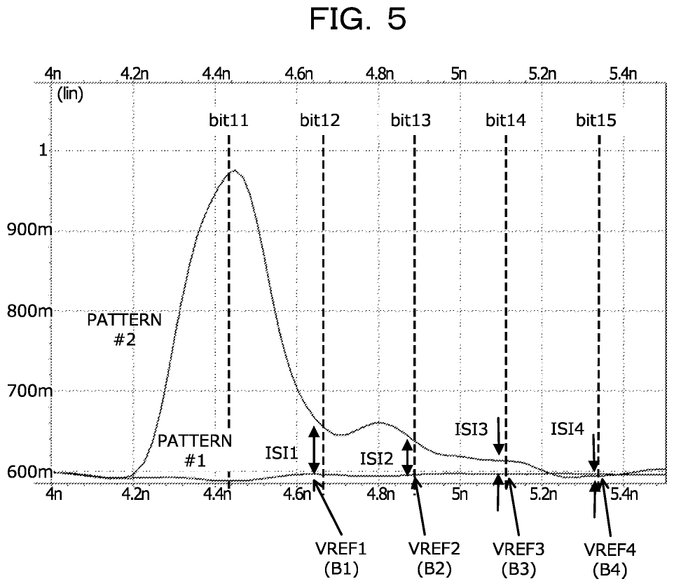

FIG. 5 is a graph illustrating waveforms at a DRAM input terminal during training according to the embodiment.

As indicated by reference numeral 131, for VREF1, ISI1 that is a difference between the pattern #1 and the pattern #2 is searched for using bit12. As indicated by reference numeral B2, for VREF2, ISI2 that is a difference between the pattern #1 and the pattern #2 is searched for using bit13. As indicated by reference numeral B3, for VREF3, ISI3 that is a difference between the pattern #1 and the pattern #2 is searched for using bit14. As indicated by reference numeral B4, for VREF4, ISI4 that is a difference between the pattern #1 and the pattern #2 is searched for using bit15.

### [A-1] Modification

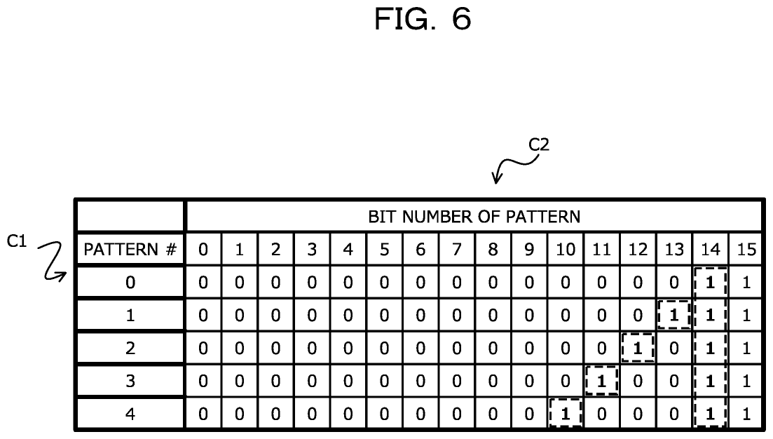

FIG. 6 is a table illustrating training patterns according to a modification.

In a case where VREF1 is out of an adjustment range of the VREF value, ISI1 is not appropriately obtained and accuracy of training decreases depending on characteristics and settings of a transmission path, a driver, and a receiver. Furthermore, in a case where ISI1 is equal to or greater than a sweep range of the TAP value, ISI1 may not be completely measured. Also in this case, the accuracy of training decreases.

Therefore, in the modification, the training patterns as illustrated in FIG. 6 may be used. In the training patterns illustrated in FIG. 6, each of bit numbers 0 to 15 indicated by reference numeral C2 is associated with patterns #0 and #4 indicated by reference numeral C1.

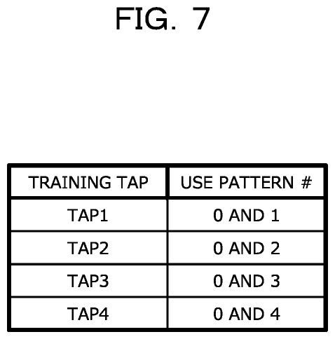

FIG. 7 is a table illustrating correspondence between training TAP and a use pattern according to the modification.

As illustrated in FIG. 7, the use patterns #0 and #1 are associated with TAP1, the use patterns #0 and #2 are associated with TAP2, the use patterns #0 and #3 are associated with TAP3, and the use patterns #0 and #4 are associated with TAP4.

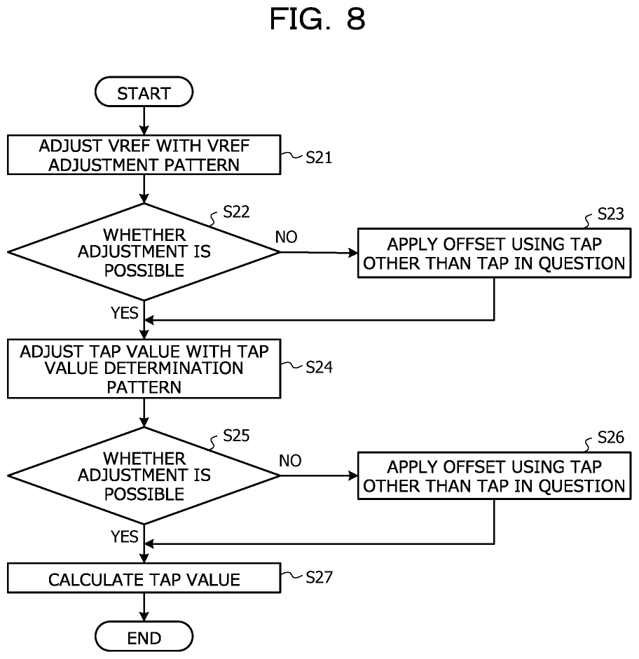

FIG. 8 is a flowchart for describing details of the TAP determination processing illustrated in FIG. 3 according to the modification.

The memory control circuit 111 adjusts VREF with a VREF adjustment pattern (operation S21).

The memory control circuit 111 determines whether VREF adjustment is possible (operation S22).

In a case where VREF adjustment is possible, the memory control circuit 111 proceeds to the processing of operation S24.

In a case where VREF adjustment is not possible, the memory control circuit 111 applies OFFSET using TAP other than the TAP in question (operation S23), and then, the processing proceeds to operation S24.

For example, the VREF value (VREF1) at which the determination value of bit14 is switched from 1 to 0 is searched for by sweeping VREF while causing the pattern #1 (for example, the first training pattern) illustrated in FIG. 6 to flow. At this time, in a case where the adjustment range has been used up before the VREF value reaches VREF1, TAP (TAP2, TAP3, or TAP4) other than the training TAP is used, and the VREF value is adjusted to VREF1.

The memory control circuit 111 adjusts TAP with the TAP adjustment pattern (operation S24).

The memory control circuit 111 determines whether TAP adjustment is possible (operation S25).

In a case where TAP adjustment is performed, the memory control circuit 111 proceeds to the processing of operation S27.

In a case where TAP adjustment is not possible, the memory control circuit 111 applies OFFSET using TAP other than the TAP in question (operation S26), and then, the processing proceeds to operation S27.

For example, the TAP value (ISI1) at which the determination value of bit14 is switched from 1 to 0 or from 0 to 1 is measured by sweeping TAP1 while causing the pattern #0 (for example, the second training pattern) illustrated in FIG. 6 to flow. At this time, in a case where the adjustment range of TAP1 has been used up before ISI1 has been measured, TAP (TAP2, TAP3, or TAP4) other than the training TAP is used and ISI1 is measured.

Then, the memory control circuit 111 calculates the TAP value to be set in TAP1 by halving ISI1 (operation S27), and the TAP1 determination processing in the modification ends. Note that, in a case where measurement is performed using TAP other than the training TAP in operation S23 or S26, the TAP value is calculated including the used TAP.

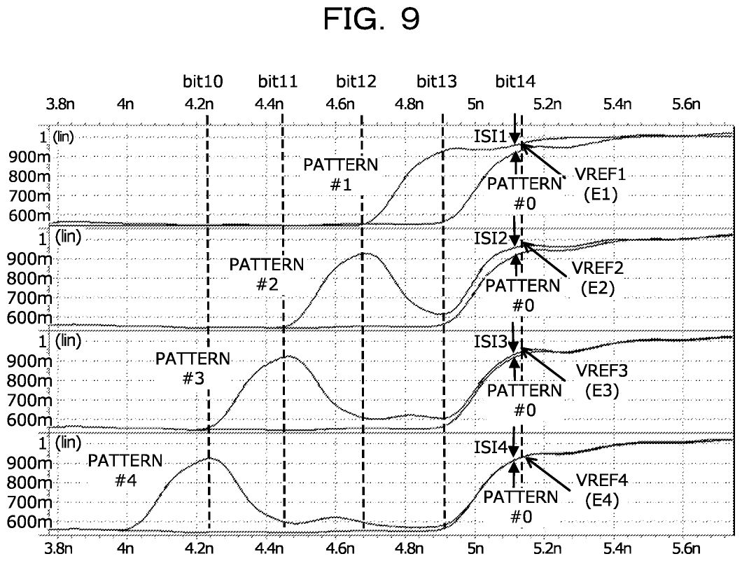

FIG. 9 is a graph illustrating waveforms at a DRAM input terminal during training according to the modification.

As indicated by reference numeral E1, for VREF1, ISI1 that is the difference between the pattern #0 (for example, the second training pattern) and the pattern #1 (for example, the first training pattern) is searched for using bit14. As indicated by reference numeral E2, for VREF2, ISI2 that is the difference between the pattern #0 and the pattern #2 (for example, the first training pattern) is searched for using bit14. As indicated by reference numeral E3, for VREF3, ISI3 that is the difference between the pattern #0 and the pattern #3 (for example, the first training pattern) is searched for using bit14. As indicated by reference numeral E4, for VREF4, ISI4 that is the difference between the pattern #0 and the pattern #4 (for example, the first training pattern) is searched for using bit14.

In the TAP determination processing in the modification, it becomes possible to use TAP other than the training TAP that is not used in the case where the bit pattern illustrated in FIG. 1 in the embodiment is used, by using the bit patterns illustrated in FIG. 6.

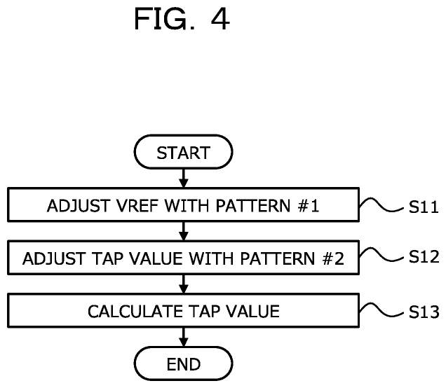

In the case of the bit pattern in the embodiment illustrated in FIG. 1, polarity is not stable because a voltage level of the bit that determines the polarity of TAP other than the training TAP is very close to a level of VREF after adjustment by the processing in operation S11 illustrated in FIG. 4. Note that the bit that determines the polarity is 1 bit before the determination bit in the case of TAP1, 2 bits before the determination bit in the case of TAP2, 3 bits before the determination bit in the case of TAP3, and 4 bits before the determination bit in the case of TAP4. Therefore, in the embodiment, TAP other than the training TAP is not used for training.

Meanwhile, in the case of the bit pattern in the modification, the voltage level of the bit that determines the polarity of the TAP other than the training TAP is sufficiently separated from the level of VREF after adjustment by the processing in operations S21 to S23. Therefore, TAP other than the training TAP is used for training.

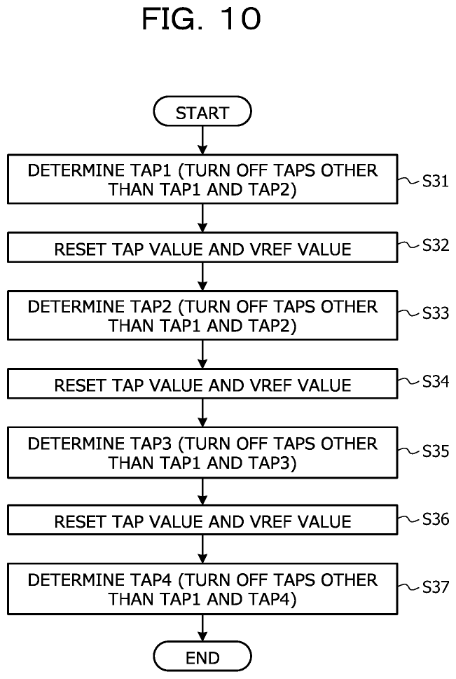

The training processing of the DFE TAP value in the modification will be described according to the flowchart (operations S31 to S37) illustrated in FIG. 10.

The memory control circuit 111 turns off TAPs other than TAP1 and TAP2 and performs TAP1 determination (operation S31).

The memory control circuit 111 resets the TAP value and the VREF value (operation S32).

The memory control circuit 111 turns off TAPs other than TAP1 and TAP2 and determines TAP2 (operation S33).

The memory control circuit 111 resets the TAP value and the VREF value (operation S34).

The memory control circuit 111 turns off TAPs other than TAP1 and TAP3 and determines TAP3 (operation S35).

The memory control circuit 111 resets the TAP value and the VREF value (operation S36).

The memory control circuit 111 turns off TAPs other than TAP1 and TAP4 and determines TAP4 (operation S37). Then, the training processing of the DFE TAP value in the modification ends.

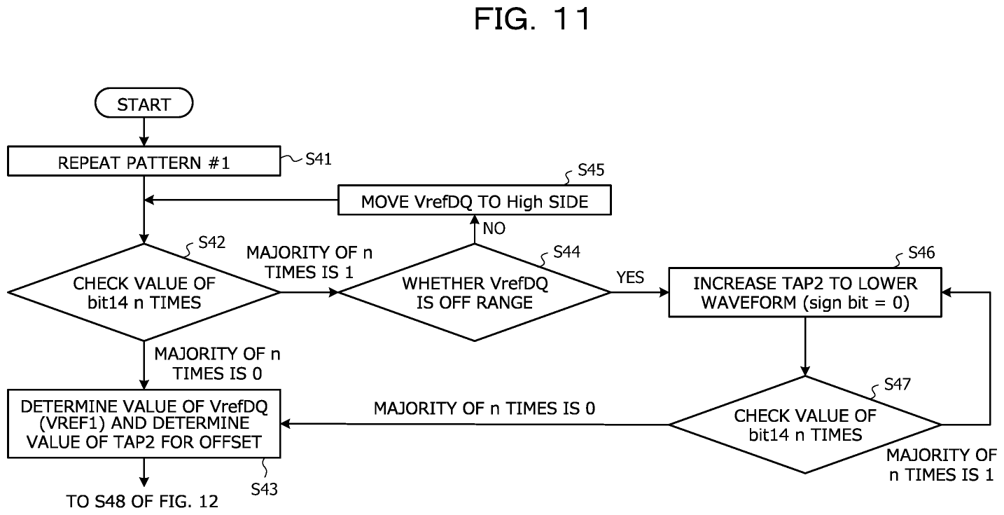

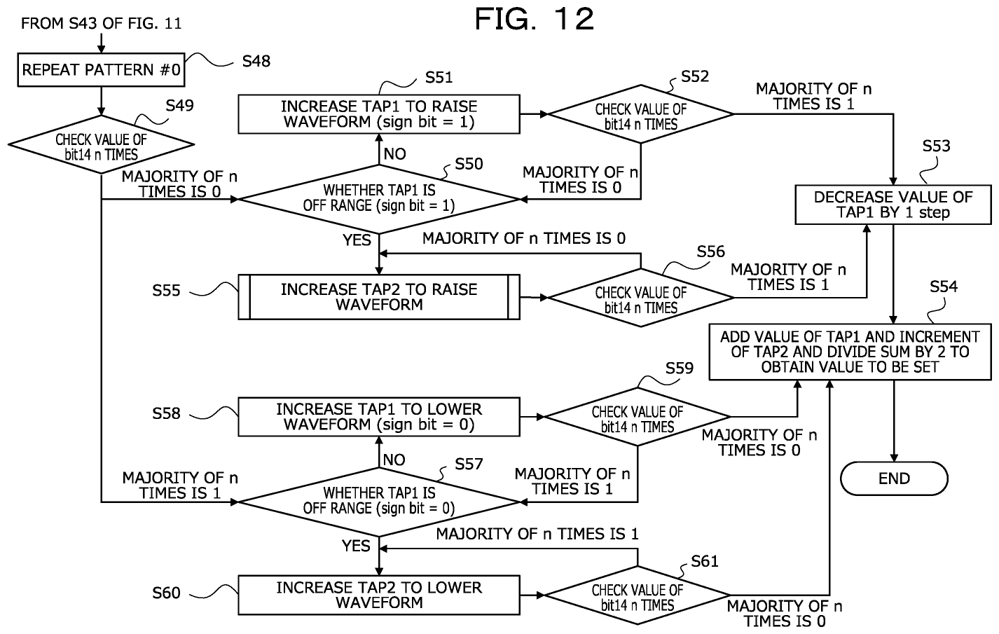

Next, details of the TAP1 determination processing illustrated in FIG. 10 will be described with reference to the flowcharts (operations S41 to S61) illustrated in FIGS. 11 and 12.

In FIG. 11, the memory control circuit 111 repeats the pattern #1 (operation S41).

The memory control circuit 111 checks the value of bit14 n times (operation S42).

In a case where the majority of n times is 0, the memory control circuit 111 determines the value of VrefDQ (VREF1) and determines the value of TAP2 for OFFSET (operation S43). Then, the processing proceeds to operation S48 in FIG. 12.

Meanwhile, in a case where the majority of n times is 1, the memory control circuit 111 determines whether VrefDQ is off the range (operation S44).

In a case where VrefDQ is not off the range, the memory control circuit 111 moves VrefDQ to High side (operation S45). Then, the processing returns to operation S42.

On the other hand, in a case where VrefDQ is off the range, the memory control circuit 111 increases TAP2 so as to lower the waveform and sets sign bit=0 (operation S46).

The memory control circuit 111 checks the value of bit 14 n times (operation S47).

In a case where the majority of n times is 1, the processing returns to operation S46.

Meanwhile, in a case where the majority of n times is 0, the processing returns to operation S43.

In FIG. 12, the memory control circuit 111 repeats the pattern #0 (operation S48).

The memory control circuit 111 checks the value of bit 14 n times (operation S49).

In a case where the majority of n times is 0, the memory control circuit 111 determines whether TAP1 is off the range and the sign bit=1 is satisfied (operation S50).

On the other hand, in a case where TAP1 is not off the range, the memory control circuit 111 increases TAP1 so as to raise the waveform and keeps the sign bit=1 (operation S51).

The memory control circuit 111 checks the value of bit 14 n times (operation S52).

In a case where the majority of n times is 0, the processing returns to operation S50.

Meanwhile, in a case where the majority of n times is 1, the memory control circuit 111 decreases the value of TAP1 by 1 step (operation S53).

The memory control circuit 111 adds the value of TAP1 and an increment of TAP2 and divides the sum by 2 to obtain the value to be set (operation S54). Then, the details of the TAP1 determination processing in the modification ends.

In operation S50, in a case where TAP1 is off the range, the memory control circuit 111 increases TAP2 so as to raise the waveform (operation S55).

The memory control circuit 111 repeats the value of bit14 n times (operation S56).

In a case where the majority of n times is 0, the processing returns to operation S55.

Meanwhile, in a case where the majority of n times is 1, the processing proceeds to operation S53.

In operation S49, in a case where the majority of n times is 1, the memory control circuit 111 determines whether TAP1 is off the range and the sign bit=0 is satisfied (operation S57).

On the other hand, in a case where TAP1 is not off the range, the memory control circuit 111 increases TAP1 so as to lower the waveform and keeps the sign bit=0 (operation S58).

The memory control circuit 111 checks the value of bit 14 n times (operation S59).

In a case where the majority of n times is 1, the processing returns to operation S57.

Meanwhile, in a case where the majority of n times is 0, the processing proceeds to operation S54.

In operation S57, in a case where TAP1 is off the range, the memory control circuit 111 increases TAP2 so as to lower the waveform (operation S60).

The memory control circuit 111 checks the value of bit14 n times (operation S61).

In a case where the majority of n times is 1, the processing returns to operation S61.

Meanwhile, in a case where the majority of n times is 0, the processing proceeds to operation S54.

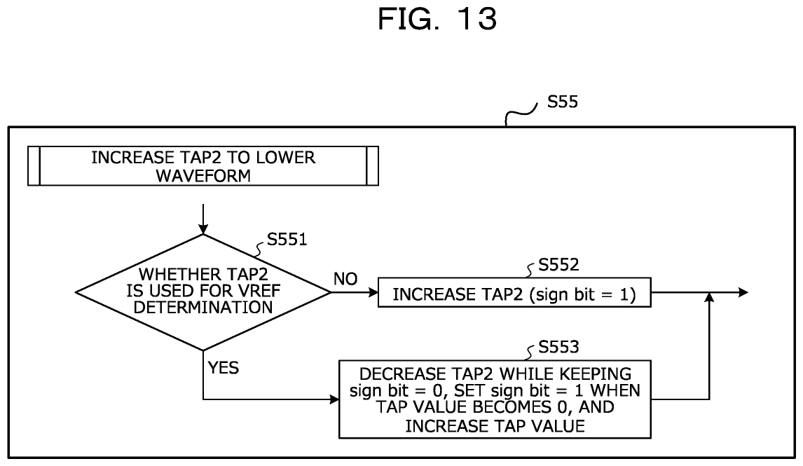

Next, details of the TAP2 increase processing illustrated in FIG. 12 will be described with reference to the flowchart (operations S551 to S553) illustrated in FIG. 13.

The memory control circuit 111 determines whether TAP2 is used for VREF determination (operation S551).

In a case where TAP2 is not used for VREF determination, TAP2 is increased and the sign bit=1 is set (operation S552). Then, the details of the TAP2 increase processing in the modification ends.

Meanwhile, in a case where TAP2 is used for VREF determination, TAP2 is decreased while the sign bit=0 is kept, and when the TAP value becomes 0, the sign bit=1 is set and the TAP value is increased (operation S553). Then, the details of the TAP2 increase processing in the modification ends.

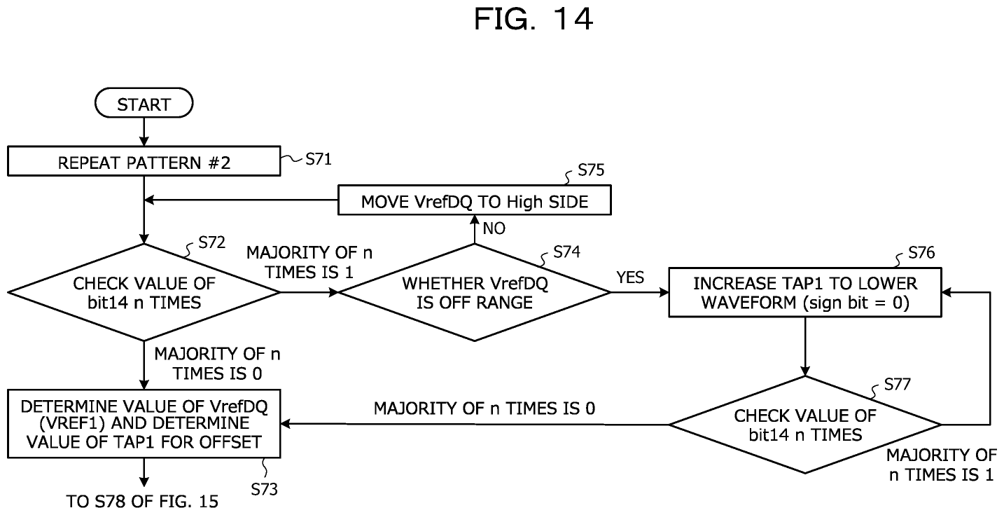

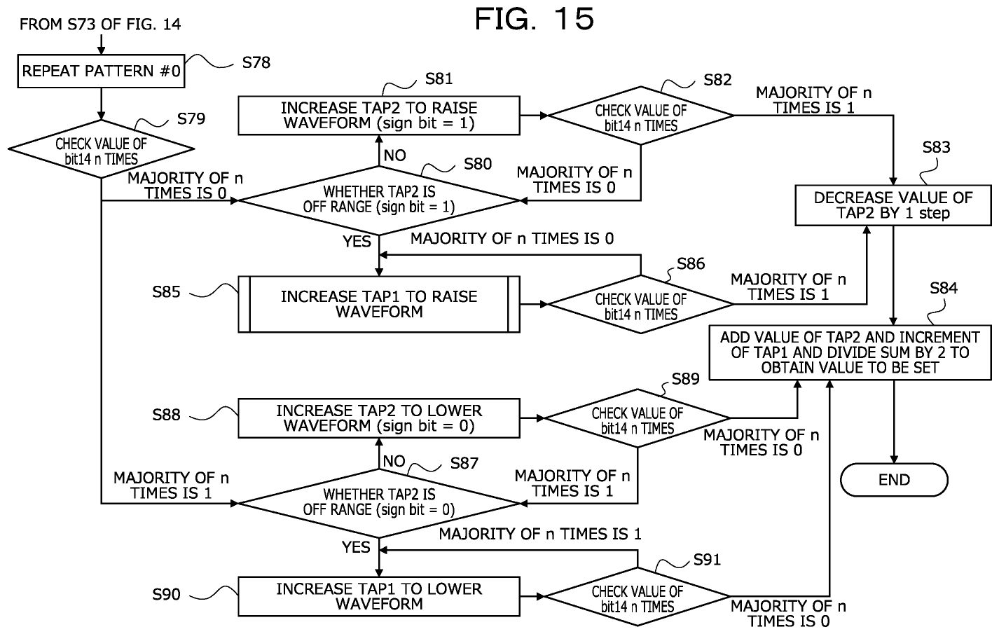

Next, details of the TAP1 determination processing illustrated in FIG. 10 will be described with reference to the flowcharts (operations S71 to S91) illustrated in FIGS. 14 and 15.

In FIG. 14, the memory control circuit 111 repeats the pattern #2 (operation S71).

The memory control circuit 111 checks the value of bit14 n times (operation S72).

In a case where the majority of n times is 0, the memory control circuit 111 determines the value of VrefDQ (VREF1) and determines the value of TAP2 for OFFSET (operation S73). Then, the processing proceeds to operation S78 in FIG. 15.

Meanwhile, in a case where the majority of n times is 1, the memory control circuit 111 determines whether VrefDQ is off the range (operation S74).

In a case where VrefDQ is not off the range, the memory control circuit 111 moves VrefDQ to High side (operation S75). Then, the processing returns to operation S72.

On the other hand, in a case where VrefDQ is off the range, the memory control circuit 111 increases TAP2 so as to lower the waveform and sets the sign bit=0 (operation S76).

The memory control circuit 111 checks the value of bit 14 n times (operation S77).

In a case where the majority of n times is 1, the processing returns to operation S76.

Meanwhile, in a case where the majority of n times is 0, the processing returns to operation S73.

In FIG. 15, the memory control circuit 111 repeats the pattern #0 (operation S78).

The memory control circuit 111 checks the value of bit 14 n times (operation S79).

In a case where the majority of n times is 0, the memory control circuit 111 determines whether TAP2 is off the range and the sign bit=1 is satisfied (operation S80).

In a case where TAP2 is not off the range, the memory control circuit 111 increases TAP2 so as to raise the waveform and keeps the sign bit=1 (operation S81).

The memory control circuit 111 checks the value of bit 14 n times (operation S82).

In a case where the majority of n times is 0, the processing returns to operation S80.

Meanwhile, in a case where the majority of n times is 1, the memory control circuit 111 decreases the value of TAP2 by 1 step (operation S83).

The memory control circuit 111 adds the value of TAP2 and an increment of TAP1 and divides the sum by 2 to obtain the value to be set (operation S84). Then, the details of the TAP2 determination processing in the modification ends.

In operation S80, in a case where TAP2 is off the range, the memory control circuit 111 increases TAP1 so as to raise the waveform (operation S85).

The memory control circuit 111 repeats the value of bit14 n times (operation S86).

In a case where the majority of n times is 0, the processing returns to operation S85.

Meanwhile, in a case where the majority of n times is 1, the processing proceeds to operation S83.

In operation S89, in a case where the majority of n times is 1, the memory control circuit 111 determines whether TAP2 is off the range and the sign bit=0 is satisfied (operation S87).

In a case where TAP2 is not off the range, the memory control circuit 111 increases TAP2 so as to lower the waveform and keeps the sign bit=0 (operation S88).

The memory control circuit 111 checks the value of bit 14 n times (operation S89).

In a case where the majority of n times is 1, the processing returns to operation S87.

Meanwhile, in a case where the majority of n times is 0, the processing proceeds to operation S84.

In operation S87, in a case where TAP2 is off the range, the memory control circuit 111 increases TAP1 so as to lower the waveform (operation S90).

The memory control circuit 111 checks the value of bit14 n times (operation S91).

In a case where the majority of n times is 1, the processing returns to operation S91.

Meanwhile, in a case where the majority of n times is 0, the processing proceeds to operation S84.

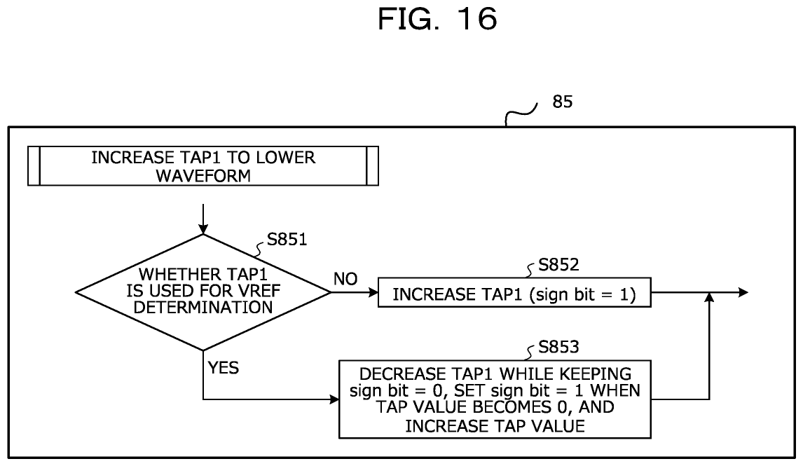

Next, details of the TAP1 increase processing illustrated in FIG. 15 will be described with reference to the flowchart (operations S851 to S853) illustrated in FIG. 16.

The memory control circuit 111 determines whether TAP1 is used for VREF determination (operation S851).

In a case where TAP1 is not used for VREF determination, TAP1 is increased and the sign bit=1 is set (operation S852). Then, the details of the TAP1 increase processing in the modification ends.

Meanwhile, in a case where TAP1 is used for VREF determination, TAP1 is decreased while the sign bit=0 is kept, and when the TAP value becomes 0, the sign bit=1 is set and the TAP value is increased (operation S853). Then, the details of the TAP1 increase processing in the modification ends.

Note that, in the modification, the bit pattern illustrated in FIG. 6 may be obtained by inverting 0 and 1. For example, a pattern (for example, a third training pattern) obtained by inverting the pattern #1 (for example, the first training pattern) and a pattern (for example, a fourth training pattern) obtained by inverting the pattern #2 (for example, the second training pattern) may be used. In this case, the search is performed such that the switching of the determination value in each bit is reversed.

Furthermore, the average value of the TAP value obtained with the bit pattern illustrated in FIG. 6 and the TAP value obtained with the inverted bit pattern may be set as the TAP value to be set. Thereby, it is possible to select the DFE TAP value equally appropriate for both of rising and falling waveforms of transmission data waveform in a case where the waveforms are different.

Although only TAP2 is used as an offset for determining TAP1 and only TAP1 is used as an offset for determining TAP2, TAP3, and TAP4, training may be performed by applying an offset using TAP other than the TAP being trained for each case. Thereby, it becomes possible to expand the range in which highly accurate adjustment is performed.

The processing of applying an offset using TAP other than the TAP being trained may be combined with the above-described case of inverting the bit pattern. Furthermore, the processing of applying an offset using TAP other than the TAP being trained may be combined with the case of setting the average value of the TAP value obtained with the bit pattern illustrated in FIG. 6 and the TAP value obtained with the inverted bit pattern as the TAP value to be set. Thereby, it becomes possible to further expand the range in which highly accurate adjustment is performed.

### [B] Effects

According to the training method, the arithmetic processing device, and the training program in the above-described embodiment, the following operational effects is obtained, for example.

The memory control circuit 111 measures an inter-symbol interference value generated in the transmission path of DDR transmission based on a control result of the training pattern, the voltage reference value of the DRAM 21, and the tap value of the DFE circuit 212. The memory control circuit 111 calculates a set tap value to be set in the DFE circuit 212 based on the measured inter-symbol interference value.

Thereby, it is possible to accurately set the tap value of the DFE circuit 212 in a short time using only the functions defined by the standard of the DRAM 21.

The memory control circuit 111 searches for the voltage reference value at which the determination value of a predetermined bit included in the first training pattern is switched from 1 to 0 using the first training pattern. The memory control circuit 111 searches for the tap value at which the determination value of a predetermined bit included in the second training pattern is switched from 0 to 1 or from 1 to 0 as the inter-symbol interference value using the second training pattern different from the first training pattern. The memory control circuit 111 calculates a half value of the searched inter-symbol interference value as the set tap value.

Thereby, it is possible to more accurately set the tap value of the DFE circuit 212.

The processing of measuring the inter-symbol interference value is executed for each of the plurality of tap values, the first training pattern is different among the plurality of tap values, and the second training pattern is common among the plurality of tap values. In a case where the voltage reference value is not searchable when using the first training pattern, the memory control circuit 111 performs a search using a tap value other than the tap value to be searched among the plurality of tap values. In a case where the inter-symbol interference value is not searchable when using the second training pattern, the memory control circuit 111 performs a search using a tap value other than the tap value to be searched.

Thereby, even in a case where VREF1 is out of the adjustment range of the VREF value regardless of the characteristics and settings of the transmission path, the driver, and the receiver, ISI1 is appropriately obtained and the accuracy of training is maintained. Furthermore, even in a case where ISI1 is equal to or larger than the sweep range of the TAP value, ISI1 is measured and the accuracy of training is maintained.

The memory control circuit 111 searches for the voltage reference value using the third training pattern obtained by inverting the first training pattern. The memory control circuit 111 searches for the inter-symbol interference value using the fourth training pattern obtained by inverting the second training pattern. The memory control circuit 111 calculates, as the set tap value, a half value of the average value of the inter-symbol interference value searched for using the second training pattern and the inter-symbol interference value searched for using the fourth training pattern.

Thereby, it is possible to select the DFE TAP value equally appropriate for both of rising and falling waveforms of transmission data waveform in a case where the waveforms are different.

### [C] Others

The disclosed technique is not limited to the embodiment described above, and various modifications may be made and carried out without departing from the spirit of the present embodiment. Each configuration and each process of the present embodiment may be selected or omitted as desired, or may be combined as appropriate.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A training method for causing a computer to execute process, the process comprising:
measuring an inter-symbol interference value generated in a transmission path of double data rate (DDR) transmission that uses a decision feedback equalizer (DFE) circuit, based on a control result of a training pattern, a voltage reference value of a dynamic random access memory (DRAM), and a tap value of the DFE circuit; and
obtaining a set tap value to be set in the DFE circuit, based on the measured inter-symbol interference value.

2. The training method according to claim 1,
wherein, in the measuring of the inter-symbol interference value, the process
searches, by using a first training pattern, for the voltage reference value at which a determination value of a predetermined bit included in the first training pattern is switched from 1 to 0, and
searches, by using a second training pattern different from the first training pattern, for the tap value at which the determination value of the predetermined bit included in the second training pattern is switched one of from 0 to 1 and from 1 to 0 as the inter-symbol interference value, and
wherein, in the obtaining of the set tap value, the process obtains a half value of the searched inter-symbol interference value as the set tap value.

3. The training method according to claim 2,
wherein, in the measuring of the inter-symbol interference value, the process executes the measuring of the inter-symbol interference value for each of a plurality of tap values, the tap value being included in the plurality of tap values,
wherein the first training pattern is different among the plurality of tap values, and
wherein the second training pattern is common among the plurality of tap values.

4. The training method according to claim 3, the process further comprising:
in a case where the voltage reference value is not searchable when using the first training pattern, performing the search of the voltage reference value by using a tap value other than a tap value to be searched among the plurality of tap values; and
in a case where the inter-symbol interference value is not searchable when using the second training pattern, performing the search of the voltage reference value by using a tap value other than the tap value to be searched.

5. The training method according to claim 2,
wherein, in the measuring of the inter-symbol interference value, the process
searches for the voltage reference value by using a third training pattern obtained by inverting the first training pattern, and
searches for the inter-symbol interference value by using a fourth training pattern obtained by inverting the second training pattern.

6. The training method according to claim 5,
wherein the process obtains, as the set tap value, a half value of an average value of the inter-symbol interference value searched for using the second training pattern and the inter-symbol interference value searched for using the fourth training pattern.

7. An arithmetic processing device comprising:
a memory; and
a processor coupled to the memory and configured to:
measure an inter-symbol interference value generated in a transmission path of double data rate (DDR) transmission that uses a decision feedback equalizer (DFE) circuit, based on a control result of a training pattern, a voltage reference value of a dynamic random access memory (DRAM), and a tap value of the DFE circuit; and
obtain a set tap value to be set in the DFE circuit, based on the measured inter-symbol interference value.

8. The arithmetic processing device according to claim 7,
wherein, in the measuring of the inter-symbol interference value, the processor
searches, by using a first training pattern, for the voltage reference value at which a determination value of a predetermined bit included in the first training pattern is switched from 1 to 0, and
searches, by using a second training pattern different from the first training pattern, for the tap value at which the determination value of the predetermined bit included in the second training pattern is switched one of from 0 to 1 and from 1 to 0 as the inter-symbol interference value, and
wherein, in the obtaining of the set tap value, the processor obtains a half value of the searched inter-symbol interference value as the set tap value.

9. The arithmetic processing device according to claim 8,
wherein, in the measuring of the inter-symbol interference value, the processor executes the measuring of the inter-symbol interference value for each of a plurality of tap values, the tap value being included in the plurality of tap values,
wherein the first training pattern is different among the plurality of tap values, and
wherein the second training pattern is common among the plurality of tap values.

10. The arithmetic processing device according to claim 9, the processor is further configured to:
in a case where the voltage reference value is not searchable when using the first training pattern, perform the search of the voltage reference value by using a tap value other than a tap value to be searched among the plurality of tap values; and
in a case where the inter-symbol interference value is not searchable when using the second training pattern, perform the search of the voltage reference value by using a tap value other than the tap value to be searched.

11. The arithmetic processing device according to claim 8,
wherein, in the measuring of the inter-symbol interference value, the processor
searches for the voltage reference value by using a third training pattern obtained by inverting the first training pattern, and
searches for the inter-symbol interference value by using a fourth training pattern obtained by inverting the second training pattern.

12. The arithmetic processing device according to claim 11,
wherein the processor obtains, as the set tap value, a half value of an average value of the inter-symbol interference value searched for using the second training pattern and the inter-symbol interference value searched for using the fourth training pattern.

13. A non-transitory computer-readable recording medium storing a training program for causing a computer to execute a process, the process comprising:
measuring an inter-symbol interference value generated in a transmission path of double data rate (DDR) transmission that uses a decision feedback equalizer (DFE) circuit, based on a control result of a training pattern, a voltage reference value of a dynamic random access memory (DRAM), and a tap value of the DFE circuit; and
obtaining a set tap value to be set in the DFE circuit, based on the measured inter-symbol interference value.

14. The non-transitory computer-readable recording medium according to claim 13,
wherein, in the measuring of the inter-symbol interference value, the process
searches, by using a first training pattern, for the voltage reference value at which a determination value of a predetermined bit included in the first training pattern is switched from 1 to 0, and
searches, by using a second training pattern different from the first training pattern, for the tap value at which the determination value of the predetermined bit included in the second training pattern is switched one of from 0 to 1 and from 1 to 0 as the inter-symbol interference value, and
wherein, in the obtaining of the set tap value, the process obtains a half value of the searched inter-symbol interference value as the set tap value.

15. The non-transitory computer-readable recording medium according to claim 14,
wherein, in the measuring of the inter-symbol interference value, the process executes the measuring of the inter-symbol interference value for each of a plurality of tap values, the tap value being included in the plurality of tap values,
wherein the first training pattern is different among the plurality of tap values, and
wherein the second training pattern is common among the plurality of tap values.

16. The non-transitory computer-readable recording medium according to claim 15, the process further comprising:
in a case where the voltage reference value is not searchable when using the first training pattern, performing the search of the voltage reference value by using a tap value other than a tap value to be searched among the plurality of tap values; and
in a case where the inter-symbol interference value is not searchable when using the second training pattern, performing the search of the voltage reference value by using a tap value other than the tap value to be searched.

17. The non-transitory computer-readable recording medium according to claim 14,
wherein, in the measuring of the inter-symbol interference value, the process
searches for the voltage reference value by using a third training pattern obtained by inverting the first training pattern, and
searches for the inter-symbol interference value by using a fourth training pattern obtained by inverting the second training pattern.

18. The non-transitory computer-readable recording medium according to claim 17,
wherein the process obtains, as the set tap value, a half value of an average value of the inter-symbol interference value searched for using the second training pattern and the inter-symbol interference value searched for using the fourth training pattern.
